(19) United States
(12) Patent Application Publication
(10) Pub. No.: US 2026/0300749 A1
(43) Pub. Date: Oct. 1, 2026

(54) FACILITATING ROOT CAUSE ANALYSIS USING FEW-SHOT LOG CLASSIFICATION, SIAMESE NETWORKS, AND MODEL PRUNING

(71) Applicant: SAP SE, Walldorf (DE)

(72) Inventor: Abhishek Vaidyanathan, Singapore (SG)

(21) Appl. No.: 19/095,265

(22) Filed: Mar. 31, 2025

(51) Int. Cl. G06N 3/092; G06N 3/045

(52) U.S. Cl. CPC G06N 3/092; G06N 3/045

(57) ABSTRACT

Methods, systems, and computer-readable storage media for providing a set of Siamese pairs, a first sub-set of Siamese pairs representing positive pairs and a second sub-set of Siamese pairs representing negative pairs, executing iterations of training of a Siamese network using the set of Siamese pairs to minimize a first loss value and provide a trained Siamese network, generating a set of embeddings by processing at least a portion of the set of training data through the trained Siamese network, executing iterations of training of a classification model using the set of embeddings to minimize a second loss value and provide a trained classification model, and deploying the trained Siamese network and the trained classification model to a cloud computing environment to process log data generated within the cloud computing environment and classify the log data in one of a first class and a second class.

### BACKGROUND

Among other activities, software development includes a process of debugging, in which errors in source code are identified and removed. Modern software systems have increasingly large and complicated source code, which results in an increasing number and complexity of software errors, commonly referred to as bugs, that are to be identified and resolved. In general, a bug can be described as an error in the software that results in the software not performing to expectations (to specification) up to and including a crash.

To facilitate debugging, bug tracking systems (e.g., Bugzilla, Jira) can be used to track and manage resolution of bugs. For example, a bug ticket can be generated and assigned to a programming team that is tasked with resolving the bug(s). However, and due to the complexity of modern software systems, the programming team is likely not intimately familiar with every module of the software system, including modules that might be key to resolving the bug(s). As such, significant technical resources can be expended as programming teams attempt to identify the source(s) of and resolve the bug(s), which also leads to extended time periods of software systems not properly operating, if not down altogether.

### SUMMARY

Implementations of the present disclosure are directed to log classification for root cause analysis in resolving errors in cloud environments. More particularly, and as described in further detail herein, implementations of the present disclosure provide a few-shot log classification system to address challenges in debugging and/or failure analysis in cloud computing environments across various domains.

In some implementations, actions include receiving a set of raining data representative of a set of classes, the set of training data including unstructured data recorded in a first sub-set of training data representative of a first class and a second sub-set of training data representative of a second class, providing a set of Siamese pairs from the set of training data, a first sub-set of Siamese pairs representing positive pairs and a second sub-set of Siamese pairs representing negative pairs, executing iterations of training of a Siamese network using the set of Siamese pairs to minimize a first loss value and provide a trained Siamese network, generating a set of embeddings by processing at least a portion of the set of training data through the trained Siamese network, executing iterations of training of a classification model using the set of embeddings to minimize a second loss value and provide a trained classification model, and deploying the trained Siamese network and the trained classification model to a cloud computing environment to process log data generated within the cloud computing environment and classify the log data in one of the first class and the second class. Other implementations of this aspect include corresponding systems, apparatus, and computer programs, configured to perform the actions of the methods, encoded on computer storage devices.

These and other implementations can each optionally include one or more of the following features: the Siamese network includes a set of pre-trained sub-networks each having a number of hidden layers, a plurality of hidden layers being pruned from each pre-trained sub-network prior to executing iterations of training of the Siamese network; the Siamese network includes sentence transformers; actions further include generating synthetic training data in response to determining that at least one of the first class the second class is under-represented in the set of training data; the set of training data includes text data and generating synthetic data comprises copying text data to provide copied text data and replacing at least one word in the copied text data with a synonym; actions further include, during an inference phase in the cloud computing environment, processing production log data to determine whether data drift is present within the cloud computing environment based on a distance between the production log data and each cluster in a set of clusters; and actions further include executing retraining in response to determining that data drift is present.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture in which implementations of the present disclosure can be executed.

FIG. 2 depicts an example architecture that can be used to execute implementations of the present disclosure.

FIG. 3A depicts an example sub-network in accordance with implementations of the present disclosure.

FIG. 3B depicts an example sub-network in accordance with implementations of the present disclosure.

FIGS. 4A-4C depict example clustering in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to log classification for root cause analysis in resolving errors in cloud environments. More particularly, and as described in further detail herein, implementations of the present disclosure provide a few-shot log classification system to address challenges in debugging and/or failure analysis in cloud computing environments across various domains.

In some implementations, actions include receiving a set of raining data representative of a set of classes, the set of training data including unstructured data recorded in a first sub-set of training data representative of a first class and a second sub-set of training data representative of a second class, providing a set of Siamese pairs from the set of training data, a first sub-set of Siamese pairs representing positive pairs and a second sub-set of Siamese pairs representing negative pairs, executing iterations of training of a Siamese network using the set of Siamese pairs to minimize a first loss value and provide a trained Siamese network, generating a set of embeddings by processing at least a portion of the set of training data through the trained Siamese network, executing iterations of training of a classification model using the set of embeddings to minimize a second loss value and provide a trained classification model, and deploying the trained Siamese network and the trained classification model to a cloud computing environment to process log data generated within the cloud computing environment and classify the log data in one of the first class and the second class.

Implementations of the present disclosure are described in further detail herein with non-limiting reference to logs that are generated in continuous integration (CI) and continuous delivery (CD) (collectively, CI/CD) pipelines. It is contemplated, however, that implementations of the present disclosure can be realized for any appropriate data recorded in any appropriate environment.

To provide further context for implementations of the present disclosure, and as introduced above, software is developed and deployed over what is commonly referred to as a software development lifecycle. A software development lifecycle can include multiple stages, such as, for example, development, testing, deployment, and maintenance. These stages can be executed through CI/CD pipelines, which can be described as an automated software development and operations (DevOps) workflow that streamlines the software delivery process. In some scenarios, CI/CD pipelines are implemented in cloud environments.

In scenarios, such as CI/CD pipelines, various log files (or simply referred to as logs) are generated, which provide data descriptive of events that have occurred. An example event can include an error, which results in the generation of a log populated with data descriptive of the error. Hundreds to thousands of logs can be generated during execution of a CI/CD pipeline, with some logs being descriptive of errors and many other logs being descriptive of other events (non-errors).

In some instances, errors require resolution to enable time- and resource-efficient provisioning of software through the CI/CD pipeline. To facilitate this, logs that are representative of errors (error logs) are processed for root cause analysis (RCA) to enable root causes of errors to be identified and resolved. However, error logs need to be identified from all of the logs that are generated. In some examples, logs predominantly contain unstructured data, such as unstructured textual data. Despite being rich in information, such logs present significant challenges in being identified as error logs for use in RCA. For example, given the unstructured, textual data recorded in the logs, determining which logs are error logs is a time- and resource-consuming process.

More particularly, processing logs containing unstructured data traditionally necessitates manual inspection to determine which logs are error logs (logs descriptive of error events). Such a manual approach is not only labor- and resource-intensive, but is also prone to error, leading to delays in resolution. This can result in adverse effects, such as extended downtime, leading to increased operational costs (e.g., increased consumption of technical resources) and reduced efficiency in the event of system failures. In some scenarios, application portfolios can include hundreds to thousands of disparate systems, and each system can require more than a single unique CI/CD pipeline. Multiples (e.g., hundreds) of such CI/CD pipelines can simultaneously fail. In such instances, there are often insufficient resources to immediately address each failure, which results in added delay and compounds operational inefficiencies and consumption of technical resources.

In an effort to address such challenges, automation of error log identification has been pursued. In one traditional approach, automation uses regular expressions, in which a regular expression represents a pattern that, if present in a log, can indicate the log as representing an error. However, regular expressions are localized to particular patterns and are not generalizable. As another option, leveraging large language models (LLMs) might be seen as a solution for automating the process, in which a few examples injected into a prompt to appropriately classify on previously unseen data. However, implementing LLMs for such tasks presents its own challenges. For example, even with appropriate filtering and chunking strategies, scalability is severely limited by rate limits and token constraints that are imposed by the third-parties that provision LLMs. These limitations hinder the ability of LLMs to handle failure analysis at scale, especially in the scenarios involving large volumes of logs.

In view of the above context, implementations of the present disclosure provide a few-shot log classification system to address challenges, such as those discussed herein, in debugging and/or failure analysis in cloud computing environments across various domains. As described in further detail herein, the few-shot log classification system of the present disclosure accurately classifies log data into relevant classes using relatively little domain-specific training data. In some implementations, the few-shot log classification system of the present disclosure leverages the minor similarities and dissimilarities between training examples to generate embeddings that capture these changes. Furthermore, implementations of the present disclosure go beyond just using pre-defined model architectures by reducing the number of parameters trained and used in inference. This approach makes it easier to scale and obviates reliance on other less generalizable and/or technically inefficient techniques, such as LLMs, thereby improving efficiencies.

In some implementations, and as described in further detail herein, the few-shot log classification system of the present disclosure includes a Siamese network architecture to generate embeddings and a classification head to classify logs. In some examples, inputs representing unique classes that a log can be assigned to are processed to form positive and negative pairs. A positive pair is a pair, in which both elements are from the same class, while a negative pair is a pair, in which the elements are from different classes. The pairs are passed through a Siamese network architecture, which is trained using contrastive loss. This ensures that the embeddings of examples from the same class are closer together, while increasing the distance between examples from different classes. The trained Siamese network is used to generate embeddings for training data and testing data samples, which are passed through a classification head to predict the classes. In some examples, data drift checks are performed to detect and effectively address any changes in the log data over time.

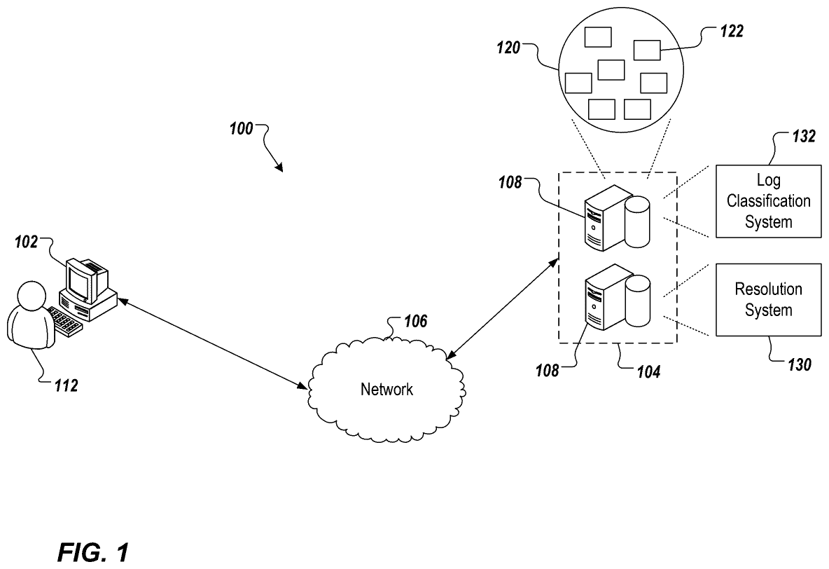

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, a CI/CD pipeline 120 can be executed within the server system 104 to provision instances 122 of applications. In some examples, processes of the CI/CD pipeline 120 to provision and execute the instances 122 of applications can result in logs being generated. In some examples, logs can include logs representative of errors, with each such log recording data representative of an underlying error. As discussed herein, logs can include unstructured data, such as unstructured textual data. In some implementations, a resolution system 130 is provided that can be used to resolve issues arising with the CI/CD pipeline 120. For example, the resolution system 130 can be provided as an information technology (IT) ticketing system that facilitates issue resolution based on log data received from the CI/CD pipeline 120.

In accordance with implementations of the present disclosure, and as noted above, the server system 104 can host a log classification system 132. As discussed herein, logs generated within cloud environments, such as through execution of the CI/CD pipeline 120, are largely populated with unstructured data, such as unstructured textual data. The log classification system 132 classifies logs as error logs or non-error, where error logs are logs that record data representative of one or more errors that are to be resolved (e.g., using the resolution system 130). As described in further detail herein, the log classification system 132 includes a Siamese network and a classification model to classify logs.

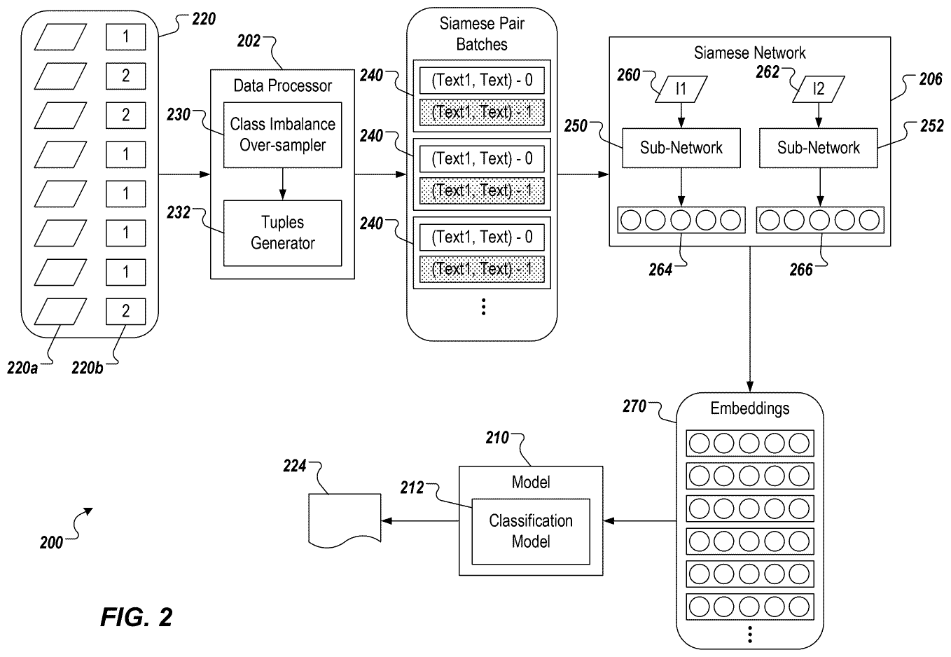

FIG. 2 depicts an example architecture 200 that can be used to execute implementations of the present disclosure. In the example of FIG. 2, the example architecture 200 includes a data processor 202, a Siamese network 206, and a model module 210. In some examples, the example architecture 200 is representative of a training phase for training of the Siamese network and a classification model 212 that is provisioned by the model module 210. In some examples, and as described in further detail herein, after training, the (trained) Siamese network 206 and the (trained) classification model 212 are deployed for production use in an inference phase.

With continued reference to FIG. 2, the Siamese network 206 and the classification model 212 are trained using a set of training data 220 to provide training results 224. In some examples, iterations of few-shot training are performed. In some examples, the training results 224 are used to determine a loss that is to be minimized over iterations (epochs) of training. In some examples, iterations of training are executed until the loss meets a threshold loss. In some examples, a pre-determined number of iterations of training are executed. In some examples, between iterations of training, parameters of the Siamese network and parameters of the classification model 212 are adjusted in an effort to reduce the loss in a next iteration of training.

In the example of FIG. 2, the data processor 202 includes a class imbalance over-sampler 230 and a tuples generator 232. As described in further detail herein, the data processor 202 processes the set of training data 220 to provide batches of Siamese pairs 240. In some implementations, the set of training data 220 includes log data 220a and labels 220b, provided in log data and label pairs. Here, each label 220b indicates a respective class that the corresponding log data belongs to (e.g., error log, non-error log). Although the example of FIG. 2 depicts two classes (e.g., 1, 2), it is contemplated that implementations of the present disclosure can be realized with any appropriate number of classes.

In some examples, each Siamese pair 240 includes a positive sample and a negative sample. Here, positive pairs are constructed of log data from the same class, while log data of negative pairs belong to different classes. In some examples, a number of Siamese pairs can be calculated as:

$$\begin{matrix}positive pairs ( {P}_{pos} ) : {\sum }_{i = 1}^{c} \frac{{n}_{i} * ( {n}_{i} - 1 )}{2} \\ negative pairs ( {P}_{neg} ) : \frac{1}{2} * ( {N}^{2} - {\sum }_{i = 1}^{c} {n}_{i}^{2} )\end{matrix}$$

where N is the total number of samples in the set of training data 220, C is the number of unique classes represented in the training data (e.g., C=2), and nᵢ is the number of samples for each class i (cᵢ). In some examples, each Siamese pair 240 includes an indication of whether a pair is positive (e.g., 0) or negative (e.g., 1).

In few-shot training, performance of the trained Siamese network 206 and the trained classification model 212 heavily depends on the representation of each class within the training set, composed of the Siamese pairs 240. As such, a balanced distribution of samples across all classes should be maintained in the training set. When a class imbalance occurs, the underrepresented class will contribute fewer Siamese pairs 240, resulting in insufficient training data for the particular class. Consequently, effective generalization to underrepresented classes is not achievable.

To address this issue, the class imbalance over-sampler 230 employs oversampling to generate synthetic samples for any underrepresented class. This ensures a more balanced and robust training process. In some examples, the class imbalance over-sampler 230 determines respective class ratios

$$( {r}_{i} = \frac{{c}_{i}}{c} )$$

and compares each to a threshold ratio (rₜₕᵣ). If a class ratio is below the threshold ratio, the class imbalance over-sampler 230 generates synthetic samples for the respective class. For example, for text data, synthetic data can be generated by replacing one or more words with respective synonym(s) and including those as synthetic training samples.

In some implementations, the tuples generator 232 provides the Siamese pairs 240 based on the samples in the set of training data 220 and any synthetic samples generated by the class imbalance over-sampler 230. That is, for example, the tuples generator 232 provides positive Siamese pairs as tuples of log data of the same class and negative Siamese pairs as tuples of log data of different classes.

In the example of FIG. 2, the Siamese network 206 includes a sub-network 250 and a sub-network 252. In some examples, the sub-network 250 and the sub-network 252 are each provided as a pre-trained ML model. That is, the sub-network 250 and the sub-network 252 are provided as copies of the same ML model, which has been pre-trained. Each of the sub-networks can be provided as any appropriate ML (e.g., transformer, LSTM). In some examples, each of the sub-network 250 and the sub-network 252 is provided as a pre-trained Bidirectional Encoder Representations from Transformers (BERT) network.

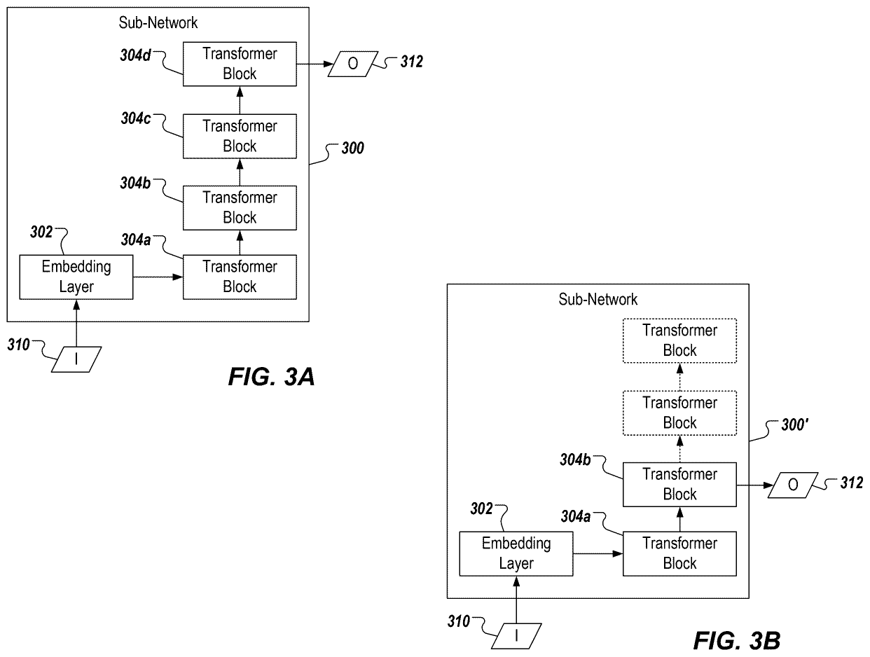

FIG. 3A depicts an example sub-network 300 in accordance with implementations of the present disclosure. In the example of FIG. 3A, the example sub-network 300 includes an embedding layer 302 and a series of transformer blocks 304a, 304b, 304c, 304d, which can be described as hidden layers. The embedding layer 302 processes an input 310 to provide an embedding (e.g., a multi-dimensional vector representation of the input 310) and the embedding is processed through the series of transformer blocks 304a, 304b, 304c, 304d. While the example of FIG. 3A depicts four transformer blocks 304a, 304b, 304c, 304d, it is contemplated that the sub-network can include any appropriate number of transformer blocks. By way of non-limiting example, an example sentence transformer includes all-mpet-base-v2, which has 13 layers with 109 million parameters including the embedding layer. The sub-network provides an output 312, which is also an embedding. During training, parameters of the sub-network 300 are adjusted, as described in further detail herein.

FIG. 3B depicts an example sub-network 300′ in accordance with implementations of the present disclosure. In the example of FIG. 3B, the example sub-network 300′ is generally identical to example sub-network 300 of FIG. 3A. However, the transformer blocks 304c, 304d have been pruned in the sub-network 300′. As such, there are fewer transformer blocks for transforming the embedding that is provided by the embedding layer 302 for the input 310. Accordingly, an output 312′ is provided from the sub-network 300′. Continuing with the non-limiting example above, the all-mpet-base-v2 sentence transformer can be pruned at the 10th layer to reduce the size by 8% down to 94 million parameters. During training, parameters of the sub-network 300′ are adjusted, as described in further detail herein. By using a sub-network that is pruned, more time- and resource-efficient training is achieved, as there are fewer parameters.

Referring again to FIG. 2, during training, inputs 260, 262 are processed through the Siamese network 206 to generate respective embeddings 264, 266. In some examples, the inputs 260, 262 are provided from a positive pair, in which both inputs 260, 262 are of the same class. In some examples, the inputs 260, 262 are provided from a negative pair, in which the inputs 260, 262 are of different classes. The embeddings 264, 266 are processed to determine a distance (e.g., Euclidean distance), which represents a degree of difference between the embeddings 264, 266.

For training of the Siamese network, it can be noted that, because the sub-networks 250, 252 are pre-trained, training of the Siamese network can technically be referred to as fine-tuning, in which pre-trained parameters are adjusted. In further detail, a loss function guides the learning process to minimize the distance between embeddings, such as the embeddings 264, 266, if generated from a positive pair, and to maximize the distance between embeddings, such as the embeddings 264, 266, if generated from a negative pair. In some examples, parameters of each of the sub-networks 250, 252 are adjusted during training using backpropagation based on a loss.

In some implementations, the loss is calculated as a contrastive loss based on the following example loss function:

$${L}_{siam} = ( 1 - Y ) * {D}^{2} + Y * max ( 0 , m - {D}^{2} )$$

where Y is a label indicating whether the pair is positive (e.g., Y=0) or negative (e.g., Y=1), D is the distance between the embeddings, and m is a margin for the minimum distance between dissimilar pairs. For a positive pair, the loss function simplifies to:

$${L}_{siam} = {D}^{2}$$

The training process seeks to reduce the distance to reduce the loss, bringing the embeddings for the positive pairs closer together. For a negative pair, the loss function simplifies to:

$${L}_{siam} = max ( 0 , m - {D}^{2} )$$

Here, and because the distance is always positive, if the distance is less than the margin (m), the loss penalizes and the training process seeks to increase the distance to separate the embeddings by at least m. If it is greater than m, the embeddings are already well separated and there is no further penalization required.

In some implementations, after the Siamese network 206 is trained (fine-tuned), the Siamese network 206 generates a set of embeddings 270. In some examples, each embedding in the set of embeddings 270 is generated from respective log data 220a. Because the sub-networks 250, 252 are identical, only one of the sub-networks 250, 252 is used to generate the set of embeddings 270. The set of embeddings 270 is used to train the classification model 212. The classification model 212 can be any appropriate model that processes embeddings to predict a class label for each embedding. In some examples, the classification model 212 is provided as a decision tree. During training, for each embedding, the classification model 212 predicts a class label that can be compared to a respective label 220b, as a ground truth, for the log data 220a used to generate the respective embedding. In some examples, categorical cross-entropy loss is used for training of the classification model 212 and can be represented as:

$${L}_{cls} = - {\sum }_{i = 1}^{C} {y}_{i} log ( \text{?} )$$

After the classification model 212 is trained, the (trained) Siamese network 206 and the (trained) classification model 212 can be deployed for production use during an inference phase. For example, the Siamese network 206 and the classification model 212 can be executed within a log classification system (e.g., the log classification system 132 of FIG. 1) to evaluate logs (e.g., logs generated by the CI/CD pipeline 120 of FIG. 1) and classify logs as either error or non-error. In some examples, logs that are classified as error logs are provided to a resolution system (e.g., the resolution system 130 of FIG. 1) for processing to resolve the underlying errors.

As noted above, between iterations of training, parameters are adjusted as features represented within the training data are learned. In some examples, using forward pass, predictions are determined by passing inputs through the network being trained, the loss is calculated using the categorical cross-entropy function on the predictions and the true labels (ground truths), a gradient of the loss is determined with respect to each parameter (weights and biases) using automatic differentiation, and parameters of the network are updated using an optimization algorithm (e.g., Adam). The updates are made to minimize the loss based on the computed gradients for subsequent iterations.

Another challenge in log analysis and classification is the dynamic nature of the logs generated. This challenge is particularly pronounced when dealing with unstructured data, such as textual data, which is inherently susceptible to variations over time. In the context of Siamese networks (such as the Siamese network 206 of FIG. 2), when training relies on representative examples from each log class, shifts in log composition or structure can lead to data drift. Changes can include new types of log lines that can belong to a new data class, significant changes in structure of logs from existing log classes, and other data variations. Such changes can result in a decline in classification accuracy, as the generated embeddings might no longer effectively capture features of the changed log patterns.

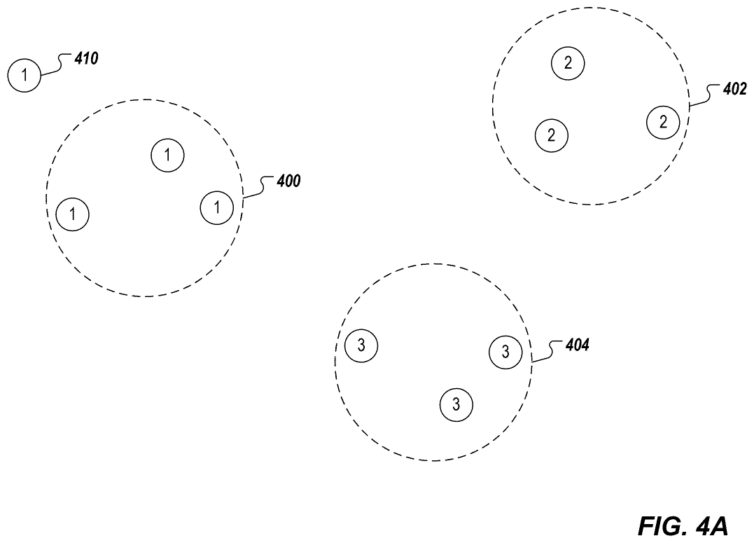

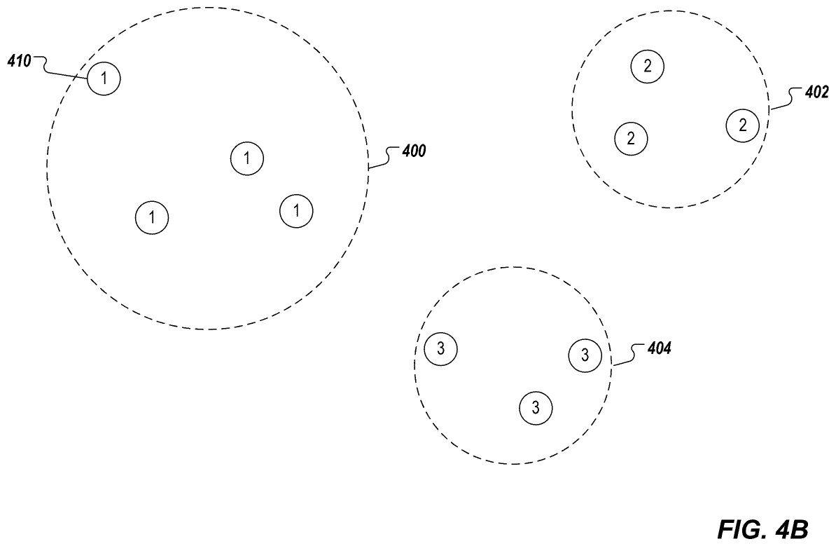

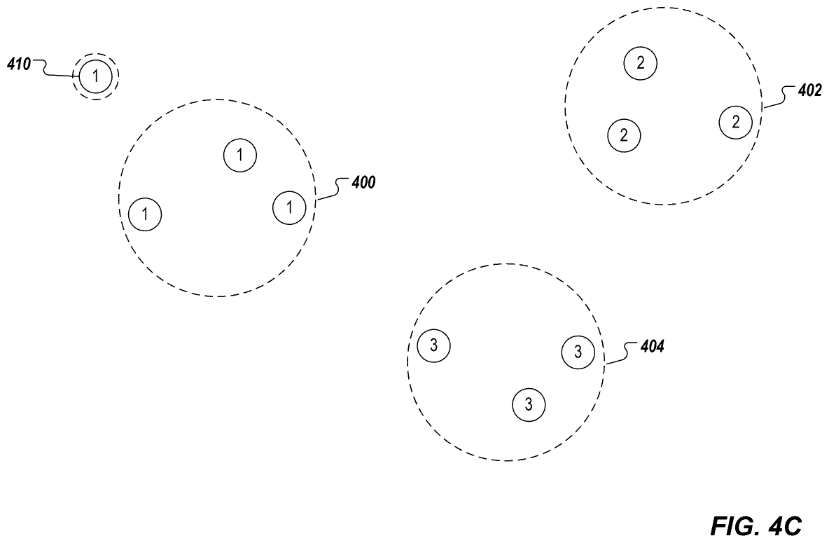

To address this challenge, implementations of the present disclosure provide a data drift mechanism to detect possible changes in incoming data patterns. Referring now to FIGS. 4A-4C, in some implementations, the set of training data used for training (e.g., the set of training data 220 of FIG. 2) is used to generate a set of clusters 400, 402, 404, each cluster representing a respective class (e.g., three classes in the examples of FIGS. 4A-4C).

In terms of generating clusters, as discussed herein, the training dataset includes logs that are labelled with respective classes (ground truth labels). The Siamese network is trained such that the logs belonging to the same class have embeddings that are closer to each other when compared to logs of different classes. During inference, the Siamese network generates embeddings that are used to form clusters using a measure of closeness which is a distance metric. Because the contrastive loss used to train the Siamese network also uses a distance measure, the same distance measure used for training the loss function is used to form the clusters. In some examples, the distance measure can be Euclidean distance or cosine similarity.

In some examples, for each cluster, a cluster boundary is defined as X times (e.g., 1.5 times) the maximum distance between any training input and centroid of the respective class. Any data point that has a distance greater than the cluster boundary can be said to have lesser correlation with the predicted class indicating that there is a plausible change in incoming data.

For example, and with reference to FIG. 4A, a data point 410 can be compared to the set of clusters 400, 402, 404. In some examples, the data point 410 represents a log that is received during production (i.e., a log that was generated after training). In the example of FIG. 4A, the data point 410 is at a distance that is greater than any of the cluster boundaries of the set of clusters 400, 402, 404. In response, the data point 410 is marked for review for potential fine-tuning of the Siamese network. If the marked data point is reviewed to still be belonging to the same class as one of the clusters, a new cluster boundary is provided as X times the distance of the new data point from the updated centroid (e.g., see FIG. 4B). On the other hand, if the data point is found not to belong to the given class, training is again performed (e.g., see FIG. 4C).

As discussed herein, re-training is executed when a significant change is seen in how a particular data point is associated with the current clusters, for example significantly far away. In some examples, when the number of such occurrences reaches a particular threshold (e.g., 5% of the training initial dataset), the data point is used for retraining (e.g., added to the training dataset initially used for training).

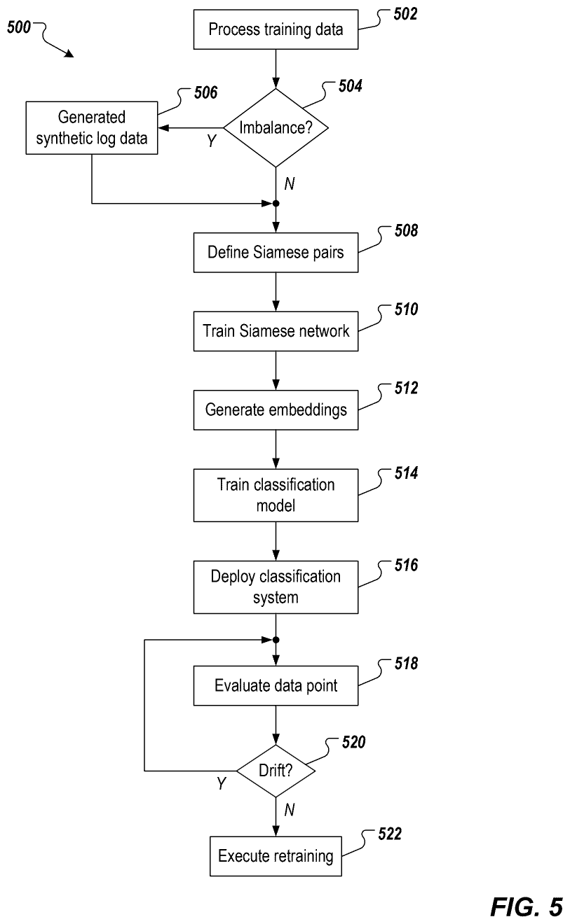

FIG. 5 depicts an example process 500 that can be executed in accordance with implementations of the present disclosure. In some examples, the example process 500 is provided using one or more computer-executable program executed by one or more computing devices.

Training data is processed (502) and it is determined whether there is class imbalance (504). For example, and as described in detail herein with reference to FIG. 2, the data processor 202 receives the set of training data 220 and the class imbalance over-sampler 230 determines respective class ratios

$$( {r}_{i} = \frac{{c}_{i}}{c} )$$

and compares each to a threshold ratio (rₜₕᵣ). If a class ratio is below the threshold ratio, the class imbalance over-sampler 230 determines that class imbalance is present in the training data. If there is class imbalance, synthetic data is generated for one or more classes (506). For example, the class imbalance over-sampler 230 generates synthetic samples for respective class(s) (i.e., under-represented classes). For example, for text data, synthetic data can be generated by replacing one or more words with respective synonym(s) and including those as synthetic training samples.

Siamese pairs are defined (508) and a Siamese network is trained (510). For example, and as described in detail herein, the tuples generator 232 provides the Siamese pairs 240 based on the samples in the set of training data 220 and any synthetic samples generated by the class imbalance over-sampler 230. That is, for example, the tuples generator 232 provides positive Siamese pairs as tuples of log data of the same class and negative Siamese pairs as tuples of log data of different classes. During training, inputs 260, 262 are processed through the Siamese network 206 to generate respective embeddings 264, 266. In some examples, the inputs 260, 262 are provided from a positive pair, in which both inputs 260, 262 are of the same class. In some examples, the inputs 260, 262 are provided from a negative pair, in which the inputs 260, 262 are of different classes. A loss function guides the learning process to minimize the distance between embeddings, such as the embeddings 264, 266, if generated from a positive pair, and to maximize the distance between embeddings, such as the embeddings 264, 266, if generated from a negative pair.

Embeddings are generated (512) and a classification model is trained (514). For example, and as described in detail herein, after the Siamese network 206 is trained (fine-tuned), the Siamese network 206 generates a set of embeddings 270 and the set of embeddings 270 is used to train the classification model 212. A classification system is deployed (516). For example, and as described in detail herein, after the classification model 212 is trained, the (trained) Siamese network 206 and the (trained) classification model 212 can be deployed for production use during an inference phase. For example, the Siamese network 206 and the classification model 212 can be executed within a log classification system (e.g., the log classification system 132 of FIG. 1) to evaluate logs (e.g., logs generated by the CI/CD pipeline 120 of FIG. 1) and classify logs as either error or non-error. In some examples, logs that are classified as error logs are provided to a resolution system (e.g., the resolution system 130 of FIG. 1) for processing to resolve the underlying errors.

A data point is evaluated (518) and it is determined whether there is data drift (520). For example, and as described in detail herein, one or more logs can be periodically selected for detection of data drift (e.g., daily, weekly, monthly). In some examples, the data point is compared to a set of clusters to determine whether the data point is at a distance that is greater than any of the cluster boundaries of the set of clusters. If the data point is within the cluster boundary of one of the clusters in the set of clusters, there is no data drift and the example process 500 loops back. If the data point is outside the cluster boundaries of all of the clusters in the set of clusters, the data point can be marked as to whether representing data drift. For example, if the data point is marked as still belonging to the same class as one of the clusters, a new cluster boundary is provided as X times the distance of the new data point from the updated centroid (e.g., see FIG. 4B), and the example process 500 loops back. If the data point is marked as not belonging to a given class (e.g., see FIG. 4C), re-training is executed 522.

As described herein, implementations of the present disclosure provide multiple technical advantages and improvements over traditional approaches. For example, the Siamese architecture includes identical sub-networks that share weights and parameters, the Siamese network extracting important features from multiple inputs and generating embeddings. Training of the Siamese network is driven by contrastive loss, enabling the Siamese network to optimize similarity measures effectively.

Leveraging the Siamese network and relatively few examples of training data from each data class, the Siamese network is trained to generate high quality embeddings by extracting features most relevant to each data class. This approach significantly reduces the reliance on large volumes of training data, while enhancing performance and scalability. Implementations of the present disclosure have been shown to achieve high accuracies with the number of training samples per class being as low as 8 samples. Compared to LLM based classification techniques, this offers a more efficient and practical solution, particularly for tasks requiring rapid adaptability and minimal data overhead.

Further, because the training data largely includes text data, implementations of the present disclosure leverage sentence transformers for sub-networks to generate embeddings. With this architecture, implementations of the present disclosure outperform LLMs in terms of efficiency, requiring fewer trained parameters to achieve comparable training accuracy. However, pretrained models usually have millions of parameters, many of which may be over-parametrized for downstream tasks. Additionally, these models often contain redundant weights that contribute minimally to overall performance. In view of this, implementations of the present disclosure include model pruning by slicing hidden layers after the embedding layer. In this manner, unnecessary computations at deeper layers are removed, which not only reduces consumption of technical resources, but decreases inference times. Furthermore, the overall model size reduces, which in turn consumes less technical resources (e.g., lower memory consumption).

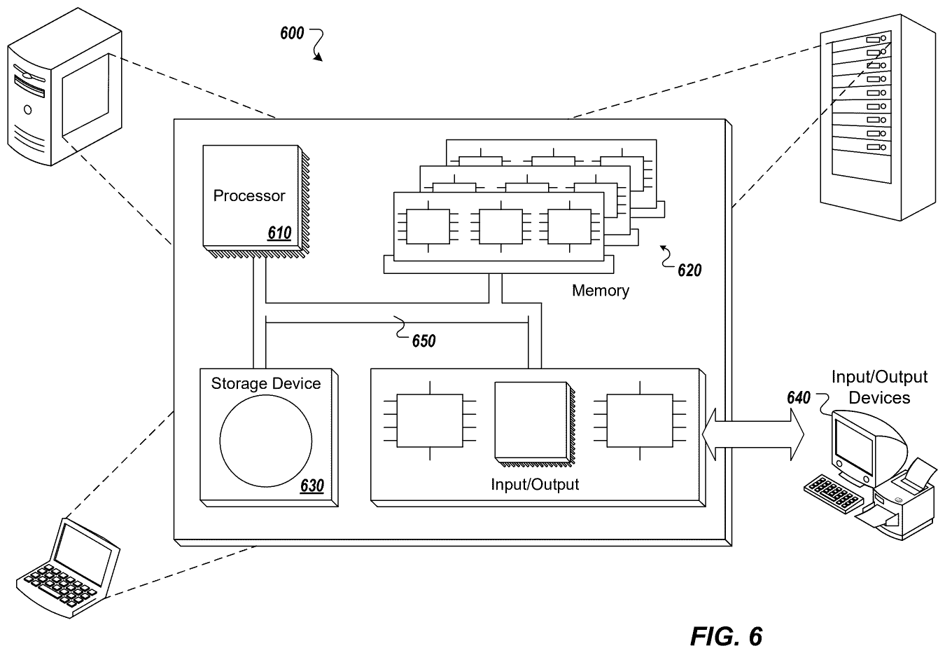

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for resolution of errors in cloud computing systems, the method being executed by one or more processors and comprising:
receiving a set of raining data representative of a set of classes, the set of training data comprising unstructured data recorded in a first sub-set of training data representative of a first class and a second sub-set of training data representative of a second class;
providing a set of Siamese pairs from the set of training data, a first sub-set of Siamese pairs representing positive pairs and a second sub-set of Siamese pairs representing negative pairs;
executing iterations of training of a Siamese network using the set of Siamese pairs to minimize a first loss value and provide a trained Siamese network;
generating a set of embeddings by processing at least a portion of the set of training data through the trained Siamese network;
executing iterations of training of a classification model using the set of embeddings to minimize a second loss value and provide a trained classification model; and
deploying the trained Siamese network and the trained classification model to a cloud computing environment to process log data generated within the cloud computing environment and classify the log data in one of the first class and the second class.

2. The method of claim 1, wherein the Siamese network comprises a set of pre-trained sub-networks each having a number of hidden layers, a plurality of hidden layers being pruned from each pre-trained sub-network prior to executing iterations of training of the Siamese network.

3. The method of claim 1, wherein the Siamese network comprises sentence transformers.

4. The method of claim 1, further comprising generating synthetic training data in response to determining that at least one of the first class the second class is under-represented in the set of training data.

5. The method of claim 4, wherein the set of training data comprises text data and generating synthetic data comprises copying text data to provide copied text data and replacing at least one word in the copied text data with a synonym.

6. The method of claim 1, further comprising, during an inference phase in the cloud computing environment, processing production log data to determine whether data drift is present within the cloud computing environment based on a distance between the production log data and each cluster in a set of clusters.

7. The method of claim 6, further comprising executing retraining in response to determining that data drift is present.

8. A non-transitory computer-readable storage medium coupled to one or more processors and having instructions stored thereon which, when executed by the one or more processors, cause the one or more processors to perform operations for resolution of errors in cloud computing systems, the operations comprising:
receiving a set of raining data representative of a set of classes, the set of training data comprising unstructured data recorded in a first sub-set of training data representative of a first class and a second sub-set of training data representative of a second class;
providing a set of Siamese pairs from the set of training data, a first sub-set of Siamese pairs representing positive pairs and a second sub-set of Siamese pairs representing negative pairs;
executing iterations of training of a Siamese network using the set of Siamese pairs to minimize a first loss value and provide a trained Siamese network;
generating a set of embeddings by processing at least a portion of the set of training data through the trained Siamese network;
executing iterations of training of a classification model using the set of embeddings to minimize a second loss value and provide a trained classification model; and
deploying the trained Siamese network and the trained classification model to a cloud computing environment to process log data generated within the cloud computing environment and classify the log data in one of the first class and the second class.

9. The non-transitory computer-readable storage medium of claim 8, wherein the Siamese network comprises a set of pre-trained sub-networks each having a number of hidden layers, a plurality of hidden layers being pruned from each pre-trained sub-network prior to executing iterations of training of the Siamese network.

10. The non-transitory computer-readable storage medium of claim 8, wherein the Siamese network comprises sentence transformers.

11. The non-transitory computer-readable storage medium of claim 8, wherein operations further comprise generating synthetic training data in response to determining that at least one of the first class the second class is under-represented in the set of training data.

12. The non-transitory computer-readable storage medium of claim 11, wherein the set of training data comprises text data and generating synthetic data comprises copying text data to provide copied text data and replacing at least one word in the copied text data with a synonym.

13. The non-transitory computer-readable storage medium of claim 8, wherein operations further comprise, during an inference phase in the cloud computing environment, processing production log data to determine whether data drift is present within the cloud computing environment based on a distance between the production log data and each cluster in a set of clusters.

14. The non-transitory computer-readable storage medium of claim 13, wherein operations further comprise executing retraining in response to determining that data drift is present.

15. A system, comprising:
a computing device; and
a computer-readable storage device coupled to the computing device and having instructions stored thereon which, when executed by the computing device, cause the computing device to perform operations for resolution of errors in cloud computing systems, the operations comprising:
receiving a set of raining data representative of a set of classes, the set of training data comprising unstructured data recorded in a first sub-set of training data representative of a first class and a second sub-set of training data representative of a second class;
providing a set of Siamese pairs from the set of training data, a first sub-set of Siamese pairs representing positive pairs and a second sub-set of Siamese pairs representing negative pairs;
executing iterations of training of a Siamese network using the set of Siamese pairs to minimize a first loss value and provide a trained Siamese network;
generating a set of embeddings by processing at least a portion of the set of training data through the trained Siamese network;
executing iterations of training of a classification model using the set of embeddings to minimize a second loss value and provide a trained classification model; and
deploying the trained Siamese network and the trained classification model to a cloud computing environment to process log data generated within the cloud computing environment and classify the log data in one of the first class and the second class.

16. The system of claim 15, wherein the Siamese network comprises a set of pre-trained sub-networks each having a number of hidden layers, a plurality of hidden layers being pruned from each pre-trained sub-network prior to executing iterations of training of the Siamese network.

17. The system of claim 15, wherein the Siamese network comprises sentence transformers.

18. The system of claim 15, wherein operations further comprise generating synthetic training data in response to determining that at least one of the first class the second class is under-represented in the set of training data.

19. The system of claim 18, wherein the set of training data comprises text data and generating synthetic data comprises copying text data to provide copied text data and replacing at least one word in the copied text data with a synonym.

20. The system of claim 15, wherein operations further comprise, during an inference phase in the cloud computing environment, processing production log data to determine whether data drift is present within the cloud computing environment based on a distance between the production log data and each cluster in a set of clusters.
